(19) United States
(12) Patent Application Publication
(10) Pub. No.: US 2013/0047603 A1
(43) Pub. Date: Feb. 28, 2013

(54) SHAPE MEMORY ALLOY ACTUATOR

(71) Applicant: OLYMPUS CORPORATION, Tokyo (JP)

(72) Inventor: Kaoru MATSUKI, Kawasaki-shi (JP)

(73) Assignee: OLYMPUS CORPORATION, Tokyo (JP)

(21) Appl. No.: 13/660,027

(22) Filed: Oct. 25, 2012

Related U.S. Application Data
(63) Continuation of application No. PCT/JP2011/054858, filed on Mar. 3, 2011.

(30) Foreign Application Priority Data
Apr. 28, 2010 (JP) 2010-103938

(51) Int. Cl. F03G 7/06

(52) U.S. Cl. 60/528

(57) ABSTRACT

A shape memory alloy actuator according to the present invention includes a shape memory alloy wire which is inserted through a tube member, a movable body which moves in a direction in which, the length of the shape memory alloy wire changes due to contraction of the shape memory alloy wire, an elastic member which exerts an external force on the movable body in a direction in which the shape memory alloy wire elongates, and a magnetic sensor which has a magnetic portion which moves with the movement of the movable body, an exciting coil which magnetizes the magnetic portion, and which is provided corresponding to the magnetic portion, and a detecting coil which outputs an electric voltage according to a relative position with respect to the magnetic portion.

### BACKGROUND OF THE INVENTION

1. Field of the Invention

The present invention relates to a shape memory alloy actuator.

2. Description of the Related Art

In a shape memory alloy there are two states namely, an austenitic phase and a martensitic phase, and a shape memory alloy has a characteristic such that, when a temperature is low, the state changes to the martensitic phase, and when the temperature is high, the state changes to the austenitic phase.

Moreover, at the time of transition (a reverse transformation) from the martensitic phase to the austenitic phase, a large distortion restoring force is generated due to a small temperature difference. The shape memory alloy actuator is an actuator in which, the distortion restoring force is used.

An actuator in which, a shape change of this shape memory alloy is used has superior characteristics from a view point of small-sizing and making light weight of the actuator.

For instance, in Japanese Patent literature No. Hei 5-87677, a technology in which, a shape memory alloy is structured such that one end of a wire material 2 of the shape memory alloy is let to be a fixed end 1 and the other end of the wire material is let to be a movable end 4, and the movable end 4 is driven by a stress due to a bias spring and a contraction force which is generated when a length of the wire material 2 of the shape memory alloy has changed by a change in temperature due to heating by applying an electric current to the wire material 2 of the shape memory alloy has been described.

Moreover, saving of space of the shape memory alloy actuator has been made possible by covering the wire material of the shape memory alloy toward the fixed end by a tube member which has an insulating property and which can be bent (refer to FIG. 7).

### SUMMARY OF THE INVENTION

Here, the shape memory alloy is distorted by an amount corresponding to the change in temperature of the shape memory alloy due to heating by passing an electric current. When such amount of distortion is to be detected, or in other words, when an attempt is to be made to detect accurately a position of the movable end (actuator 4) in the shape memory alloy actuator (refer to FIG. 7) described in Japanese Publication after Examination No, Hei 5-87677, it is necessary to position a sensor for detecting the position near the movable end (actuator 4).

However, in a case of mounting separately the position sensor for detecting the position of the movable end (actuator 4) at an outer side of the shape memory alloy actuator, the size and weight of the shape memory alloy actuator becomes bulky, which leads to an increase in restrictions from a point of view of usage and layout, thereby making the shape memory alloy actuator difficult to use.

The present invention has been made in view of the abovementioned circumstances, and an object of the present invention is to provide a shape memory alloy actuator which is capable of acquiring information of a position and an amount of movement accurately in addition to a function as an actuator, while having a structure to suppress spreading in a cross-sectional direction which is perpendicular to a direction of contraction and elongation of the actuator.

To solve the abovementioned issues and to achieve the object, the shape memory alloy actuator according to the present invention includes

a shape memory alloy wire which is inserted through a tube member, and of which a length changes by being contracted due to heating by passing an electric current, and being elongated due to cooling,

a movable body which moves in a direction in which the length of the shape memory alloy wire changes due to contraction and elongation of the shape memory alloy wire,

an elastic member which exerts an external force in a direction in which, the shape memory alloy wire elongates, and

a magnetic sensor which has a magnetic portion having an outer diameter smaller than an outer diameter of the tube member or an outer diameter of the movable body, which moves with the movement of the movable body, and a plurality of coils which includes an exciting coil which supplies an electric voltage and a detecting coil which outputs a varying electric voltage according to a relative position with respect to the magnetic portion.

Moreover, according to a preferable aspect of the present invention, it is desirable that the coil has a circular cylindrical shape, and an axis of movement of the magnetic portion connected to the movable body and a central axis of the circular cylindrical shaped coil is the same axis

According to a preferable aspect of the present invention, it is desirable that the exciting coil and the detecting coil are disposed in series along a direction of movement of the movable body.

According to a preferable aspect of the present invention, it is desirable that the detecting coil consisted of a first detecting coil and a second detecting coil, and

the exciting coil is disposed between the first detecting coil and the second detecting coil.

According to a preferable aspect of the present invention, it is desirable that a wire member of which, a length does not change upon passing an electric current is connected to the movable body, and the magnetic portion is installed on the wire member of which, the length does not change upon passing an electric current.

According to a preferable aspect of the present invention, it is desirable that the magnetic portion is formed by a magnetic body or by coating.

According to a preferable aspect of the present invention, it is desirable that the magnetic portion is formed by a magnetic material being coated on the wire member.

According to a preferable aspect of the present invention, it is desirable that the magnetic portion is formed by a magnetic material being coated on the shape memory alloy wire.

Moreover, according to a preferable aspect of the present invention, it is desirable that the exciting coil and the detecting coil are disposed to be isolated mutually at least in the direction of movement of the movable body.

According to the present invention, it is possible to provide a shape memory alloy actuator which is capable of acquiring information of a position and an amount of movement accurately in addition to a function as an actuator, while having a structure to suppress spreading in a cross-sectional direction which is perpendicular to a direction of contraction and elongation of the actuator.

### BRIEF DESCRIPTION OF THE DRAWINGS

FIG. 1 is a cross-sectional view showing schematically an overall structure of a shape memory alloy actuator according to a first embodiment of the present invention;

FIG. 2 is a cross-sectional view showing schematically an overall structure of a shape memory alloy actuator according to a second embodiment of the present invention;

FIG. 3 is a cross-sectional view showing schematically an overall structure of a shape memory alloy actuator according to a third embodiment of the present invention;

FIG. 4 is a cross-sectional view showing schematically an overall structure of a shape memory alloy actuator according to a fourth embodiment of the present invention;

FIG. 5 is a cross-sectional view showing schematically an overall structure of a shape memory alloy actuator according to a fifth embodiment of the present invention;

FIG. 6 is a cross-sectional view showing schematically an overall structure of a shape memory alloy actuator according to a sixth embodiment of the present invention; and

FIG. 7 is a partial cross-sectional view showing schematically an overall structure of a conventional shape memory alloy actuator.

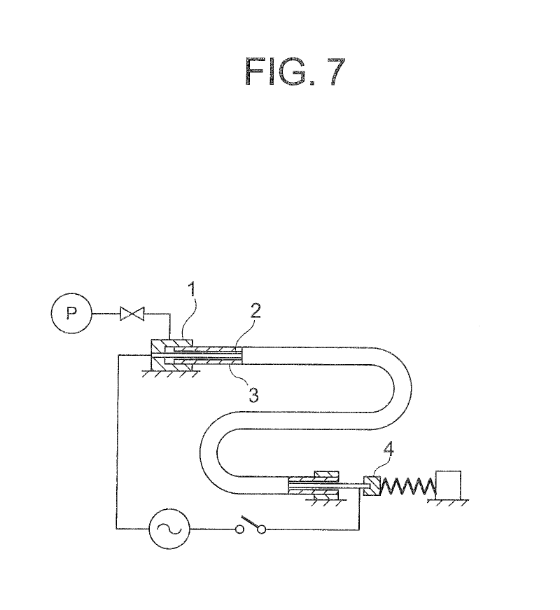

### DETAILED DESCRIPTION OF THE INVENTION

Exemplary embodiments of a shape memory alloy actuator according to the present invention will be described below in detail by referring to the accompanying diagrams. However, the present invention is not restricted to the embodiments described below. The description will be made by assigning same reference numerals to components which are same in the following embodiments.

### First Embodiment

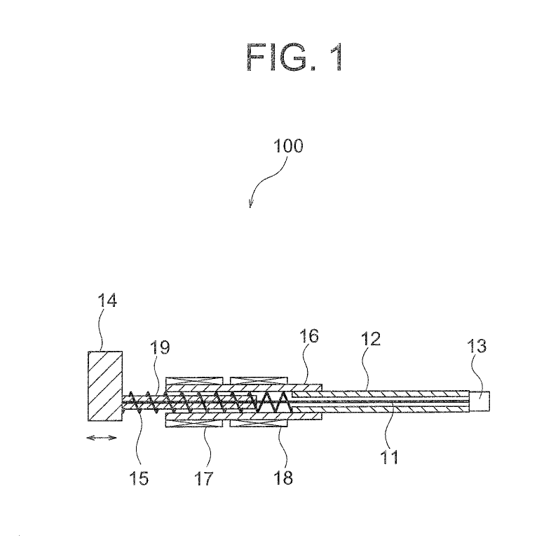

FIG. 1 is a diagram showing an overall structure of a shape memory alloy actuator according to a first embodiment of the present invention.

As shown in FIG. 1, a shape memory alloy wire 11 in a shape memory alloy actuator 100 according to the present invention is inserted through a tube member 12 for insulating from outside, and one end thereof is connected to a fixed member 13.

The other end thereof is connected to a movable body 14. An electric current is applied to both ends of the shape memory alloy wire 11. When heated by passing electric current, the shape memory alloy wire 11 reaches a transformation temperature. By the shape memory alloy wire 11 being deformed (in this case, a length of the shape memory alloy wire 11 contracts), the movable body 14 moves according to the deformation of the shape memory alloy wire 11.

The shape memory alloy wire 11 contracts due to heating by passing an electric current, and for regaining the length before heating by cooling, the shape memory alloy wire 11 elongates by an action of a bias spring 15 which exerts a force in a direction in which the shape memory alloy wire 11 elongates.

The bias spring 15 without being buckled, is inserted into a tube member 16 disposed at an opposite side of the fixed member 13 of the tube member 12 such that the shape memory alloy wire 11 passes through a center of an inner diameter of the bias spring 15.

Two coils 17 and 18 are wound around the tube member 16, side-by-side in a longitudinal direction of the tube member 16. In such manner, by the coils 17 and 18 being disposed in series in a direction of movement, it is possible to make small an outer diameter of the actuator.

Moreover, a magnetic member 19 which can be inserted through the tube member 16 (and through an inner diameter of the bias spring 15) is connected to the movable body 14. The magnetic member 19 is an example of a magnetic portion according to the present invention, and is made of a magnetic material. A diameter of the magnetic member 19 is smaller than the inner diameter of the tube member 16 and the inner diameter of the bias spring 15 (or the tube member 12), and is disposed in series with the movable body 14 in the direction of movement thereof.

When the coil 17 toward the movable body 14 is let to be an exciting coil and the other coil 18 is let to be a detecting coil, when the exciting coil 17 is excited by an alternate current (constant-frequency voltage), since an induced voltage corresponding to a relative position of the magnetic member 19 for the detecting coil is generated toward the detecting coil 18, it is possible to detect the position by selecting this voltage.

In other words, as shown in FIG. 1, since the magnetic member 19 connected to the movable body 14 moves relatively with respect to the detecting coil 18 due to the contraction of the shape memory alloy wire 11, by detecting the induced voltage generated corresponding to the relative movement, it is possible to detect the position of the movable body 14 (the magnetic member 19 is inserted all the time through the exciting coil 17).

In this case, the exciting coil 17, the detecting coil 18, and the magnetic member 19 of the first embodiment form a part of a magnetic sensor according to the present invention.

Generally, for detecting the position of the movable body 14, a position sensor is to be provided outside the shape memory alloy actuator and the position of the movable body 14 is to be detected. However, in this case, the position sensor is to be installed outside the shape memory alloy actuator, and the size of the shape memory alloy actuator becomes large.

Whereas, as exemplified in the first embodiment, since it is possible to build a position detecting sensor by disposing the magnetic member 19 at an interior of a member forming the shape memory alloy actuator 100, and by disposing the coils 17 and 18 at a periphery thereof, it is possible to prevent an enlargement of the size.

In the first embodiment, the magnetic member 19 is fixed to the movable body 14. However, without restricting to such arrangement, the magnetic member 19 may be disposed in series with the movable body 14 or may be connected integrally to the shape memory alloy wire 11 connected to the movable body 14, near the coils 17 and 18.

Moreover, it is desirable that the exciting coil 17 and the detecting coil 18 are disposed to be isolated mutually at least in the direction of movement of the movable body 14. By disposing the two coils to be isolated in such manner, a degree of freedom of space for disposing increases, and furthermore it is possible to suppress the size.

### Second Embodiment

Next, a second embodiment of the present invention will be described below.

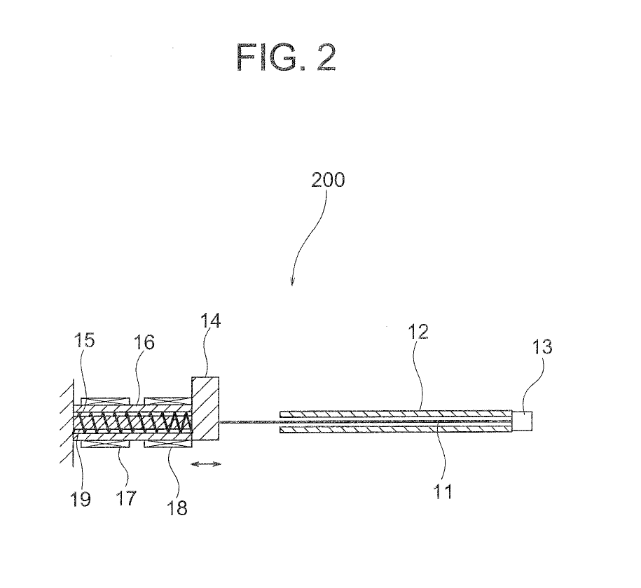

FIG. 2 shows an example of a structure of a shape memory alloy actuator 200 according to the second embodiment. The second embodiment is equivalent to a modified embodiment of the first embodiment.

In the first embodiment shown in FIG. 1, the bias spring 15 is a compression spring which when compressed; a load is exerted in a direction of elongation of the shape memory alloy wire 11. However, without restricting to such a compression spring, an extension spring may be used.

Therefore, in the second embodiment, as shown in FIG. 2, an extension spring is used as the bias spring 15. In such manner, when the extension spring is used as the bias spring 15, it is possible to let the magnetic member 19 to be columnar shaped (not circular cylindrical shaped), and the shape memory alloy wire 11 is not to be inserted through the magnetic member 19, thereby making it easy to assemble.

### Third Embodiment

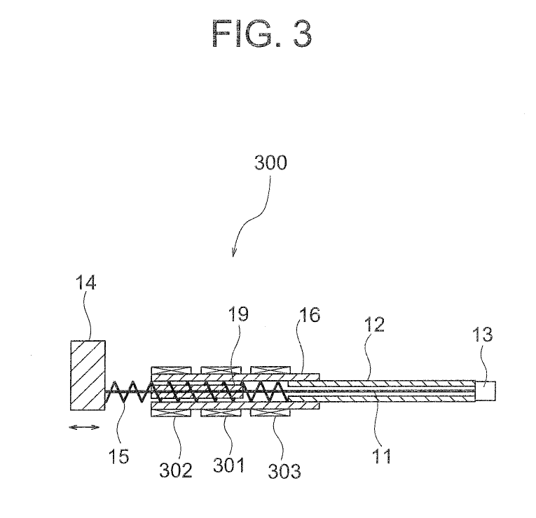

FIG. 3 is a diagram in which a third embodiment of the present invention is shown.

As shown in FIG. 3, in a shape memory alloy actuator 300 according to the third embodiment, two detecting coils 302 and 303 are disposed to sandwich an exciting coil 301 in between. When such an arrangement is made, since a voltage corresponding to a relative position of the magnetic member 19 with respect to each of the detecting coils 302 and 303 is output, by letting a difference between the two outputs to be position information, highly accurate position detection becomes possible.

### Fourth Embodiment

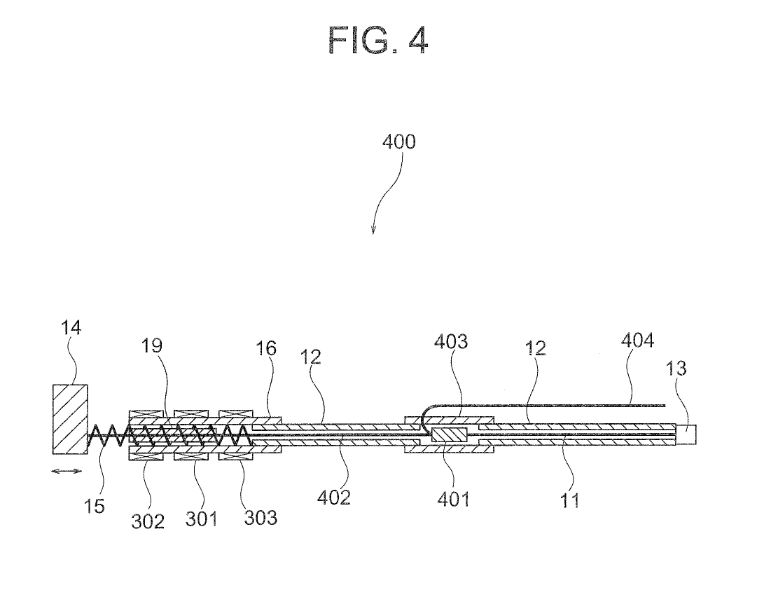

FIG. 4 is a diagram in which a fourth embodiment of the present invention is shown.

As shown in FIG. 4, in a shape memory alloy actuator 400 according to the fourth embodiment, the shape memory alloy wire 11 is connected to a wire member (non-deforming portion) 402 via a joining portion 401, and the shape memory alloy wire 11 is capsuled in the tube member 12.

By disposing the wire member in such manner, it is possible to separate the shape memory alloy wire which is a source of heat from a coil. Therefore, since a change in a resistance value of a coil wire which is caused due to a rise in temperature ceases, the accuracy of position detection is further improved.

The wire member 402 is a member which functions as a non-deforming portion of which a length does not change substantially in accordance with a change in temperature (thermal coefficient of linear expansion is small). A wire member having a predetermined bending stiffness (buckling resistance) such as a resin wire or a rod-shaped element and a linear element apart from a normal metallic wire or a rod-shaped element and a linear element for instance, can be used as the wire member 402. Here, the wire member 402 of the fourth embodiment corresponds to the wire member according to the present invention.

A surrounding area of the joining portion 401 is enclosed by a pipe member 403, and two ends of the pipe member 403 are inserted through a corresponding circumference of the tube member 12 which is divided.

The other end of the wire member 402 contracts due to heating by passing an electric current to the shape memory alloy wire 11 connected to the movable body 14, and with the contraction of the other end of the wire member 402, the movable body 14 connected to the wire member 402 moves.

When such an arrangement is made, it is possible to dispose a heat source such as the shape memory alloy wire 11 away from the coil (the exciting coil 301 and the two detecting coils 302 and 303), and the rise in the resistance value of the coil wire due to the rise in temperature is suppressed. Therefore, it is possible to draw the induced voltage from the magnetic member 19 accurately, thereby improving the accuracy of position detection.

In this case, the exciting coil 301, the detecting coils 302 and 303, and the magnetic member 19 of the fourth embodiment form a part of the magnetic sensor according to the present invention.

Moreover, when a conducting wire 404 for heating by passing an electric current, of the shape memory alloy wire 11 is supplied from the joining portion 401, a wire constraining the movable body 14 is eliminated. Therefore, it is possible to move the movable body 14 more smoothly.

Furthermore, although it is not shown in the diagram, it is possible to make the diameter further smaller by omitting the magnetic member 19 shown in FIG. 4, and applying by coating or plating a magnetic material at a site corresponding to the wire member 402 instead of the magnetic material 19.

For instance, coating or plating the magnetic material on the shape memory alloy wire 11 described in embodiments from the first embodiment to the third embodiment, and omitting the magnetic member 19 may also be taken into consideration. However, in this case, the magnetic material to be coated or plated is sought to be contracted according to the contraction of the shape memory alloy wire 11 and not to be exfoliated, which limits the magnetic materials which can be coated or plated on the shape memory alloy wire 11.

However, in a case of the fourth embodiment, the wire member 402 is not to be heated directly and also the contraction is small, which makes the selection of the magnetic material comparatively easier, and it is also possible to select the wire member 402 according to the material to be coated. Therefore, it is possible to select a material in which, the induced voltage can be generated easily, and it is possible to contribute to the improvement of the accuracy of the position sensor.

In such manner, for suppressing the rise in temperature of the detecting coils 302 and 303, and the wire member 402, it is desirable to make an arrangement by using a material having a small heat-transfer coefficient (or/and coefficient of thermal conductivity) (such as ceramic) as the joining portion 401 so that the heat is not transferred easily (or even if the heat is transferred, there is no conduction) from the side of the shape memory alloy wire 11 toward the wire member 402.

### Fifth Embodiment

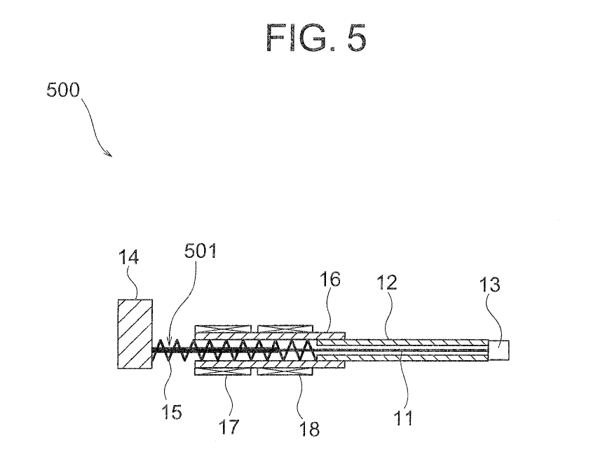

FIG. 5 is a diagram in which, a fifth embodiment is shown. As shown in FIG. 5, in a shape memory alloy actuator 500 according to the fifth embodiment, a magnetic material 501 is applied by coating or plating on a part of the shape memory alloy wire 11 toward the movable body 14.

In such manner, by applying the magnetic material 501 on a part of the shape memory alloy wire by coating or platting, further reduction in diameter is possible.

By applying the magnetic material 501 by a method such as coating on the shape memory alloy wire 11, it is possible to omit the magnetic member 19 described in the embodiments from the first embodiment to the third embodiment, and to make the diameter of the portion further smaller. Therefore, since it is possible to make the diameter of the tube member 16 and the diameter of the bias spring 15 small, further reduction in diameter becomes possible.

In this case, the portion on which the magnetic material 501 is applied in the fifth embodiment corresponds to an example of the magnetic portion according to the present invention.

A material such as nickel maybe taken into consideration as the magnetic material 501 which can be applied by coating or plating on the shape memory alloy wire 11.

### Sixth Embodiment

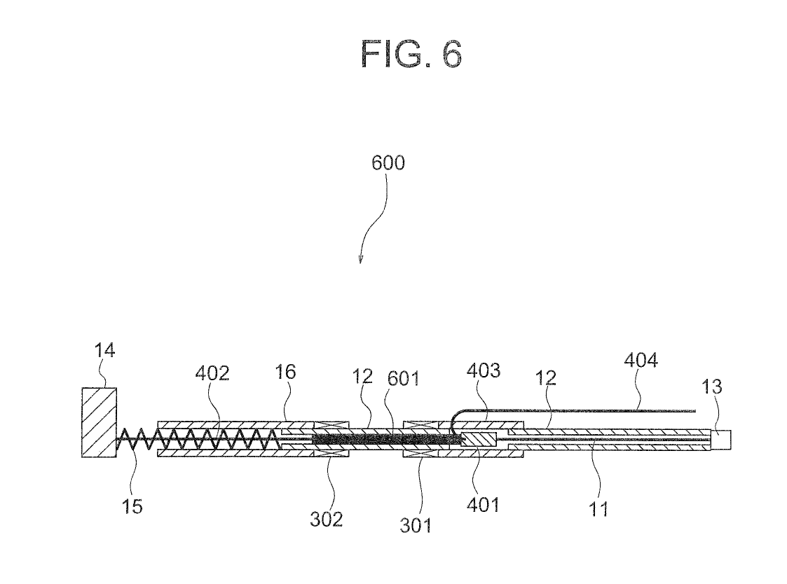

FIG. 6 is a diagram in which, a sixth embodiment of the present invention is shown.

As shown in FIG. 6, in a shape memory alloy actuator 600 according to the sixth embodiment, a magnetic material (such as nickel) is applied by coating or plating on a part (a magnetic portion 601) of the wire member 402 of the shape memory alloy actuator.

In such manner, by applying a magnetic material on a wire member, further reduction in diameter becomes possible. Moreover, since it is possible to select a material having further superior characteristics (such as easy to generate induced voltage), and to select the wire member according to the material applied, it is possible to improve further the accuracy of position detection.

In this case, the portion on which the magnetic material is applied on the wire member in the sixth embodiment corresponds to an example of the magnetic portion according to the present invention.

Accordingly, since it is not necessarily required anymore to dispose the coil (magnetic sensor: exciting coil 301 and detecting coil 302) to be installed corresponding to the magnetic portion near the movable body 14, it is possible to dispose the two coils (exciting coil 301 and the detecting coil 302) to be isolated at a predetermined distance at two-end sides of the tube member 12 which encloses a surrounding area of the magnetic portion 601 as shown in FIG. 6.

When such an arrangement is made, since an outer diameter of the magnetic sensor becomes small, an outer diameter of the shape memory alloy actuator also does not become large. In the example in FIG. 5 in which the magnetic material is applied on the shape memory alloy wire, an arrangement similar to the arrangement in FIG. 6 is possible for the portion of the magnetic sensor.

The embodiments described above are mere exemplifications for describing the present invention, and various changes may be made without departing from the scope of the present invention.

As it has been described above, the shape memory alloy actuator according to the present invention is capable of acquiring information of a position and an amount of movement accurately in addition to a function as an actuator, while having a structure to suppress spreading in a cross-sectional direction which is perpendicular to a direction of contraction and elongation of the actuator.

What is claimed is:

1. A shape memory alloy actuator comprising:
a shape memory alloy wire which is inserted through a tube member, and of which a length changes by being contracted due to heating by passing an electric current, and being elongated due to cooling;
a movable body which moves in a direction in which the length of the shape memory alloy wire changes due to contraction and elongation of the shape memory alloy wire;
an elastic member which exert an external force in a direction in which, the shape memory alloy wire elongates; and
a magnetic sensor which has a magnetic portion having an outer diameter smaller than an outer diameter of the tube member or an outer diameter of the movable body, which moves with the movement of the movable body, and a plurality of coils which includes an exciting coil which supplies an electric voltage and a detecting coil which outputs a varying electric voltage according to a relative position with respect to the magnetic portion.

2. The shape memory alloy actuator according to claim 1, wherein
the coil has a circular cylindrical shape, and
an axis of movement of the magnetic portion connected to the movable body and a central axis of the circular cylindrical shaped coil is the same axis.

3. The shape memory alloy actuator according to claim 1, wherein the exciting coil and the detecting coil are disposed in series along a direction of movement of the movable body.

4. The shape memory alloy actuator according to claim 1, wherein
the detecting coil includes a first detecting coil and a second detecting coil, and
the exciting coil is disposed between the first detecting coil and the second detecting coil.

5. The shape memory alloy actuator according to one of to claim 1, wherein
a wire member of which, a length does not change upon passing an electric current is connected to the movable body, and
the magnetic portion is installed on the wire member of which, the length does not change upon passing an electric current.

6. The shape memory alloy actuator according to claim 1, wherein the magnetic portion is formed by a magnetic body or by coating.

7. The shape memory alloy actuator according to claim 6, wherein the magnetic portion is formed by a magnetic material being coated on the wire member.

8. The shape memory alloy actuator according to claim 6, wherein the magnetic portion is formed by a magnetic material being coated on the shape memory alloy wire.

9. The shape memory alloy actuator according to claim 1, wherein the exciting coil and the detecting coil are disposed to be isolated mutually at least in the direction of movement of the movable body.
